(19) United States
(12) Patent Application Publication
(10) Pub. No.: US 2012/0217007 A1
(43) Pub. Date: Aug. 30, 2012

(54) ACOUSTIC MONITORING OF HYDROCARBON PRODUCTION

(75) Inventors: Helge Brandsaeter, Hamresanden (NO); Lars M. Pedersen, Radal (NO)

(73) Assignee: OCTIO GEOPHYSICAL AS, Bergen (NO)

(21) Appl. No.: 13/389,851

(22) PCT Filed: Aug. 21, 2009
(86) PCT No.: PCT/IB2009/053686

§ 371 Date: Apr. 23, 2012

(51) Int. Cl. E21B 47/14; E21B 43/16; G01V 1/40

(52) U.S. Cl. 166/250.01; 166/65.1

(57) ABSTRACT

The present invention relates to a method for monitoring hydro-carbon production from a hydrocarbon reservoir comprising the steps of performing a reservoir treatment process for stimulating hydrocarbon production including injection of a fluid into the reservoir, performing a seismic survey on the reservoir, obtaining a set of acoustic signals from said seismic survey and determine from the obtained acoustic signals the distribution of different contents within the reservoir, wherein the method comprises an intermediate step of adding a substance for increasing the acoustic contrast of the fluid prior to or in conjunction with injecting the fluid into the reservoir.

### TECHNICAL FIELD

The present invention relates to a method for monitoring hydrocarbon production from a hydrocarbon reservoir including acoustic signals.

### BACKGROUND ART

Recovery of hydrocarbons is based on various processes of extraction from an underground reservoir or well. Initially, when a hydrocarbon reservoir is new, the content will exit the well due to natural pressure mechanisms such as expansion of gas dissolved in the crude oil and gravity drainage. As the amount of oil within the reservoir decreases the pressure will fall, and the underground pressure will eventually become insufficient to force the oil to the surface. In order to recover the remaining amounts of reservoir content it is common to inject fluids into the reservoir thus creating a pressure support and displacing oil from reservoir pockets and push it towards the oil production well. Such forced recovery of hydrocarbons from the reservoir are generally called secondary recovery, and will substantially enhance oil production.

An essential part of hydrocarbon production is monitoring the reservoir and well, meaning gathering and analyzing information therefrom. A reservoir will contain a number of different substances, like high or low viscosity oil, gas and/or water, all of which will occupy space within the reservoir as well as within pockets and cavities that extend from the main chamber. The propagation of different substances within the reservoir needs to be monitored and analyzed during recovery of hydrocarbons so that correct and precise information can be collected about position of the content. One way of attaining like information is to produce a seismic map showing the whole reservoir at different stages of the hydrocarbon production. This is shown for instance in U.S. Pat. No. 4,354,381 which presents a method for using resonance behavior to distinguish between oil-rich, gas-rich and water-rich zones.

Another related document, US2009/097358, discloses monitoring of heavy oil recovery in a hydrocarbon reservoir. Here, a set of acoustic signals is obtained and used for relating fluid parameters (e.g. viscosity, density, bulk and shear moduli) within the reservoir with the compressional and shear wave velocities of sound propagation within the reservoir.

A known problem with conventional acoustic monitoring is that acoustic properties of different rock types will vary substantially, and acoustic properties of the oil will also differ between separate reservoirs which means it is often hard to perform precise detections in order to determine the position of different zones. In addition, sometimes it is difficult to analytically separate water from hydrocarbon content meaning mistakes can be made which is evidently undesirable since it complicates the extraction processes and leads to uneconomical and time consuming procedures.

### OBJECTS OF THE INVENTION

It is a primary object of the present invention to provide an improved method for acoustic monitoring of hydrocarbon reservoirs whereby precise information of the content within underground reservoirs and cavities is retrieved.

### DISCLOSURE OF THE INVENTION

The primary object of the present invention is achieved through a method for monitoring hydrocarbon production from a hydrocarbon reservoir comprising the steps of performing a reservoir treatment process for stimulating hydrocarbon production including injection of a fluid into the reservoir, performing a seismic survey on the reservoir, obtaining a set of acoustic signals from said seismic survey and determine from the obtained acoustic signals the distribution of different contents within the reservoir. Further, according to the present invention, the method comprises an intermediate step of adding a substance for increasing the acoustic contrast of the fluid prior to or in conjunction with injecting the fluid into the reservoir.

Increasing the acoustic contrast may include increasing the viscosity of the fluid, and/or alter the compressibility thereof, both of which examples will lead to of acoustically better distinguishable properties of the injection fluid compared to surrounding matters.

The injection fluid with added substance for increasing acoustic contrast is hereinafter referred to as contrast fluid or injection contrast fluid.

Thanks to increasing the acoustic contrast of the fluid that is injected into the reservoir acoustic measurements will easily distinguish between different matters within the reservoir or well, and it will be possible to detect and locate various zones of material in a cost effective and simplified way. Such an improvement within monitoring processes will provide a way of carefully and precisely plan the extraction of hydrocarbon from the underground reservoir so that the work will be substantially easier to perform.

According to one aspect of the invention the injection fluid is water, which has the advantage of being a very potent solvent, and dissolves a large variety of other substances.

Moreover, the substance for increasing the acoustic contrast of the injection fluid is preferably a type of polymer that increases the viscosity of the fluid upon dissolving.

Preferably the acoustic signals to be used according to the inventive method include seismic signals, for instance caused by so-called airguns or other types of acoustic sources or other types of impact forces giving rise to propagating waves. Recording of such seismic signals may be done with a hydrophone or other suitable conventional instrument.

### BRIEF DESCRIPTION OF THE DRAWINGS

FIG. 1 illustrates a sequence of steps according to an example of the present invention.

### DETAILED DESCRIPTION OF THE INVENTION

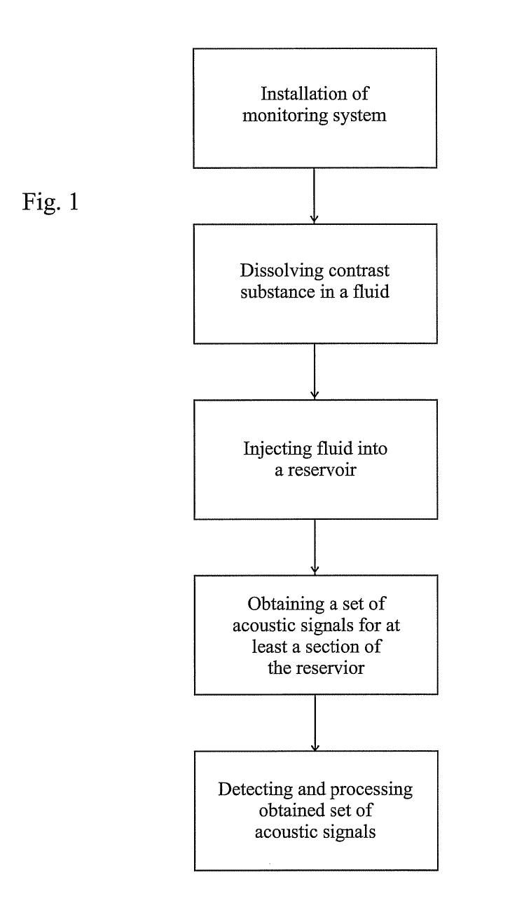

FIG. 1 is described as follows. A monitoring system is initially installed next to the reservoir, which monitoring system includes seismic sources and receivers distributed at suitable positions around the reservoir to be monitored.

Typically a seismic monitoring system is permanently installed on the seafloor above the reservoir. Such a monitoring system comprises sensor modules mounted in cables trenched 1-2 meters below the surface. The sensor modules typically have a distance of 25 m or 50 m along the cable. The cables with sensors are installed to form a regular grid with distance between cables ranging between 200 m-500 m. Each sensor module will preferably include a 4 component sensor comprising a hydrophone and a 3 component particle velocity- or particle acceleration sensor, i.e. 3 component geophones or 3 component accelerometers.

The seismic sources can be permanently installed on the seafloor. However in most cases the source will be deployed from a vessel traversing in a regular grid and emitting an acoustic signal, typically every 50 m

Furthermore; seismic monitoring systems can be installed permanently in-well between the production tubing and the casing to provide more detail in the near-well environment.

Seismic monitoring is not limited to the use of permanent systems. Repeat towed streamer 4D can be used for larger area 4D reconnaissance surveys as well as in cases where reservoir changes is expected to happen slowly.

A chemical substance for increasing the acoustic contrast is added to and dissolved in a fluid (the injection fluid), whereupon the fluid which is premixed with the contrast substance is injected and displaced into the hydrocarbon reservoir. It understood that it is equally possible that the chemical substance for increasing the acoustic contrast is added into the reservoir in conjunction with the fluid stream during injection into the reservoir, in which case the mixing of the fluid and the chemical substance occurs at the injection procedure itself. The chemical substance for increasing the acoustic contrast of the injection fluid may for instance be a polymer, like xxxxxxxx. However, for the skilled person within the field it is evident that various substances may be utilized to achieve the desired functionality in accordance with the invention.

As a result of fluid injection hydrocarbon production may proceed due to increased reservoir pressure. At regular occasions during such production said seismic sources are activated leading to emission of acoustic signals propagating through the reservoir and its content. Seismic receivers detect the acoustic signals and the data hereby obtained is used in order to generate a seismic map, and/or to calculate the position of various matters within the reservoir. The specific acoustic property of the injection contrast fluid will enable for an operator to monitor the propagation of different contents/zones within the reservoir, the displacement of hydrocarbons due to extraction, and to detect the oil-water-contact which represents the transition zone between water and oil in the reservoir.

The contrast properties of the injection fluid may be designed differently for every reservoir depending on the content within that specific reservoir. Such adjustments may be done based on results from preparatory tests e.g. in a laboratory where a sample taken from the reservoir in question is compared to various compositions of contrast fluids. After that enough data has been collected it will be sufficient just taking a test sample from a well in order to judge what composition of contrast injection fluid is suitable in order to attain the best contrasting property of the injection fluid compared to the content of the reservoir.

The contrast injection fluid will provide a dual function. Firstly, it will enable for acoustic discerning of different zones and propagations of various contents and secondly, the contrast injection fluid provides an acoustic reference in relation to other substances within the reservoir. Since the acoustic properties of the injection fluid is defined it is possible to use this information in order to gather data about other matter that are monitored during hydrocarbon production.

Any calculations or data processing necessary for retrieving said seismic map or other types of desired data are of conventional, known type. For instance, a well known way of predicting seismic velocities in rocks saturated with one fluid from the velocities in rocks saturated with a second fluid or from dry rock velocities is using Gassmann's equations (Gassman, F. 1951).

It is to be understood that FIG. 1 and the detailed description of the method according to the invention only represents an example, and that it is evident for the skilled person that variations of the invention may be performed within the scope of the appended claims.

### REFERENCES

Gassman, F., 1951, Über die Elastizität poroser Medien: Veirteljahrsschrift der Naturforschenden Gesellschaft in Zürich 96, 1-23.

1-6. (canceled)

7. A method for monitoring hydrocarbon production from a hydrocarbon reservoir comprising the steps of:
performing a reservoir treatment process for stimulating hydrocarbon production including injecting an injection fluid into the reservoir;
performing a seismic survey on the reservoir;
obtaining a set of acoustic signals from the seismic survey; and
determining from the obtained acoustic signals the distribution of different contents within the reservoir, wherein an intermediate step of adding a substance for increasing the acoustic contrast of the injection fluid prior to or in conjunction with injecting the injection fluid into the reservoir is performed, and wherein the substance for increasing the acoustic contrast comprises a polymer for increasing the viscosity of the injection fluid.

8. A method according to claim 7, further comprising injecting water as the injection fluid.

9. A method according to claim 7, wherein the acoustic signals include seismic signals.

10. A method according to claim 7, further comprising premixing the injection fluid and the substance for increasing the acoustic contrast prior to injection into the reservoir.

11. A method according to claim 7, further comprising mixing the substance for increasing the acoustic contrast into the injection fluid stream in conjunction with injection into the reservoir.

12. System for monitoring hydrocarbon production from a hydrocarbon reservoir comprising:
means for performing a reservoir treatment process for stimulating hydrocarbon production including injection of a fluid into the reservoir;
means for performing a seismic survey on the reservoir;
means for detecting acoustic signals from said seismic survey;
means for determining from the obtained acoustic signals the distribution of different contents within the reservoir; and
means for adding a substance for increasing the acoustic contrast of the fluid prior to or in conjunction with injecting it into the reservoir.
